(19) United States
(12) Patent Application Publication
(10) Pub. No.: US 2026/0126082 A1
(43) Pub. Date: May 7, 2026

(54) METHOD FOR MOUNTING A ROLLING BEARING AND POSITIONING DEVICE FOR POSITIONING A SHIM RING DURING MOUNTING OF A ROLLING BEARING

(71) Applicant: Robert Bosch GmbH, Stuttgart (DE)

(72) Inventors: Daniel Schwartz, Wiernsheim (DE); Tobias Schlittenbauer, Tamm (DE)

(21) Appl. No.: 19/122,326

(22) PCT Filed: Sep. 27, 2023
(86) PCT No.: PCT/EP2023/076643

§ 371 Date: Apr. 18, 2025

(30) Foreign Application Priority Data
Oct. 19, 2022 (DE) 10 2022 211 050.1

(51) Int. Cl. F16C 43/04

(52) U.S. Cl. CPC F16C 43/04

(57) ABSTRACT

The invention relates to a method for mounting a rolling bearing (10) of a bearing arrangement (12) into a housing (14) with a first housing part (16) and a second housing part (18), wherein a bearing seat (24) for the rolling bearing (10) is arranged on an inner side (20) of the first housing part (16), wherein the method comprises the following steps: providing the bearing arrangement (12) with the rolling bearing (10); positioning the bearing arrangement (12) in the second housing part (18); providing and positioning a shim ring (20) on the bearing seat (24); holding the shim ring (26) in the bearing seat (24) by means of magnetic interaction and connecting the first housing part (16) to the second housing part (18), wherein as a result of the connection, the rolling bearing (10) is pushed into the bearing seat (24), wherein, during connection, the shim ring (26) is held in the bearing seat (24) by means of magnetic interaction. The invention also relates to a positioning device (28) for positioning a shim ring (26) during mounting of a rolling bearing (10).

### BACKGROUND

Drive arrangements, in particular electrical axes (E-axes), use bearing arrangements with rolling bearings. Shim rings can be used to compensate for bearing play in the rolling bearings and to bias the rolling bearings. For this purpose, the biased rolling bearings are measured while already mounted on the shaft (distance between the bearings). In addition, the corresponding bearing seat depths are measured. Then, considering various influencing factors and the desired biasing force, a thickness for the shim ring is calculated. This is mounted between the bearing and the bearing shoulder in the bearing seat.

To mount the shim ring, it can be placed on the rolling bearing as the rolling bearing is pressed into the bearing seat.

A disadvantage of this method is that the shim ring can easily slip, making this process step comparatively unstable.

### SUMMARY

The invention proposes a method for mounting a rolling bearing of a bearing arrangement into a housing with a first housing part and a second housing part.

The bearing arrangement may be a shaft with one or more rolling bearings, particularly two rolling bearings, each mounted on the shaft. The housing may be configured as a gear housing. The first housing part may be configured as a gear cover.

The first housing part has an inner side and an outer side. A bearing seat for the rolling bearing is arranged or formed on the inner side of the first housing part.

The method comprises the steps of:
Providing the bearing arrangement with the rolling bearing.
Positioning (or mounting) the bearing arrangement in the second housing part.
Providing a shim ring.
Positioning the shim ring on the bearing seat (or on the inner side of the first housing part).

Holding (or fixing) the shim ring in the bearing seat (or on the inner side of the first housing part) by means of magnetic interaction. The shim ring can interact magnetically with a positioning device.

Connecting (mounting) the first housing part to the second housing portion. In particular, closing the second housing part with the first housing part. As a result of the connection of the first housing part to the second housing part, the rolling bearing is pushed into the bearing seat. During the connection of the first housing part to the second housing part, the shim ring is held (or fixed) in the bearing seat (or on the inner side of the first housing part) by means of magnetic interaction, in particular with the positioning device.

When the two housing parts are mounted on one another or connected to one another (“housing mounted”), the shim ring is located between the rolling bearing and the first housing part. The shim ring is held in the desired (final) position in the bearing seat by magnetic interaction, in particular shortly before and during mounting of the rolling bearing into the bearing seat.

This allows the shim ring to be held in the desired position, in particular during mounting of the rolling bearing into the bearing seat, so that sliding of the shim ring can be prevented and secure mounting of the rolling bearing into the bearing seat can be ensured.

According to a further development, the method may comprise at least one of the following steps:

Outputting a signal when the position of the shim ring in the bearing seat (or on the inner side of the first housing part) deviates from a predetermined (desired) position. The signal may be an optical (e.g., red light) or an acoustic signal.

Outputting a signal when the shim ring is arranged at the predetermined (desired) position in the bearing seat (or on the inner side of the first housing part). The signal can be an optical (e.g., green light) or an acoustic signal.

This can indicate the correct or incorrect position of the shim ring by simple means.

According to a further development, a positioning device as described in the following embodiments can be used to perform the method. With respect to the advantages that can be achieved in this way, reference is made to the explanations regarding the positioning device. The measures described and/or discussed below in connection with the positioning device can serve the further design of the method.

According to the invention, a positioning device for positioning a shim ring is proposed for mounting a rolling bearing of a bearing arrangement into a housing with a first housing part and a second housing part.

The bearing arrangement may be a shaft with one or more rolling bearings, particularly two rolling bearings, each mounted on the shaft. The housing may be configured as a gear housing. The first housing part may be configured as a gear cover.

The first housing has an inner side and an outer side. A bearing seat for the rolling bearing is arranged or formed on the inner side of the first housing part.

The positioning device includes at least one magnet. The positioning device can be positioned or arranged on the outer side of the first housing. The positioning device is configured so that when it is positioned or arranged on the outer side of the first housing part, a shim ring positioned or arranged in the bearing seat is held or fixed in the bearing seat (or on the inner side of the first housing part) by means of magnetic interaction between the shim ring and the magnet of the positioning device.

The shim ring can be held in the desired position by means of the positioning device, in particular during the mounting of the rolling bearing into the bearing seat, so that sliding of the shim ring can be prevented and secure mounting of the rolling bearing into the bearing seat can be ensured.

According to one further development, the positioning device can include several, in particular three, magnets. The magnets can be arranged in or on the positioning device so that the arrangement of the magnets corresponds to the shape of a section of the shim ring. The arrangement of the magnets may correspond to the shape of a section of the shim ring. The magnets can be arranged so that they are lie together on an (imaginary) circular arc or arc section.

This can increase the magnetic interaction between the magnets and the shim ring, thereby increasing the holding force with which the shim ring is held. This further reduces the risk of the shim ring sliding.

According to a further development, the magnet or magnets can each be movably arranged or mounted in the positioning device along a direction of movement between a first position and a second position.

In the second position, the magnet or magnets may be minimally distant from the shim ring, and in the first position, maximally distant from the shim ring when the positioning device is arranged on the outer side of the first housing part. In the second position, the magnet or magnets may contact the outer side of the first housing part.

The magnet or magnets may be moved to the second position due to the magnetic interaction with the shim ring. If the shim ring is not positioned correctly or as desired in the bearing seat, the magnetic interaction with the shim ring may be weaker and insufficient to move the magnet or magnets to the second position. If the magnets have moved to the second position, it can be concluded that the shim ring is in the correct or desired position in the bearing seat.

According to one further development, the positioning device may include a biasing device. The magnet or magnets of the positioning device may each be biased to the first position by means of the biasing device. The biasing device may include at least one coil spring, wherein the magnet or magnets may each be biased to the first position by means of the coil spring.

This can ensure that the magnet or magnets are arranged in the first position, in particular when they are not in magnetic interaction with the shim ring.

According to a further development, the biasing device can be configured so that the biasing of the magnet or magnets is individually adjustable. The biasing may be individually adjustable for each magnet or adjustable for all magnets together.

By adjusting the biasing, the force required to move the magnet or magnets out of the first position can be adjusted.

According to a further development, the positioning device may include a sensor device. The sensor device may be configured to detect whether the magnet or magnets are arranged in the second position. The sensor device may be configured to detect whether the magnet or magnets are arranged in the first position. The sensor device may be configured to detect whether the magnet or magnets are in the first or second position. The sensor device may include at least one inductive sensor for detection.

This can determine in which position the magnet or magnets are arranged along the respective direction of movement. If the magnet or magnets are in the first position when the positioning device is arranged on the outer side of the first housing part and the shim ring is positioned in the bearing seat, it can be concluded that the shim ring is not positioned at the predetermined desired position. If the magnet or magnets are in the second position, it can be concluded that the shim ring is positioned at its predetermined desired position.

According to one further development, the mounting device may comprise a display device. The display device may be configured to indicate whether the magnet or the magnets have been detected by means of the sensor device as being arranged in the second position. The display device may be configured to indicate whether the magnet or the magnets have been detected by means of the sensor device as being arranged in the first position. The display device can be configured for the visual display. An acoustic indicator is also conceivable.

This may indicate the position in which the magnet or magnets are arranged along the respective direction of movement and thus whether the shim ring has been positioned properly.

### BRIEF DESCRIPTION OF THE DRAWINGS

Embodiments of the invention are explained below with reference to the accompanying drawings. Shown are:

FIG. 1 a perspective view of a positioning device according to a first exemplary embodiment;

FIG. 2 a perspective view of the positioning device according to FIG. 1 positioned on an outer side of a first housing part;

FIG. 3 a perspective view of the positioning device according to a second exemplary embodiment;

FIG. 4 a sectional view of the positioning device according to FIG. 3, and

FIG. 5 a representation of a method for mounting a rolling bearing.

### DETAILED DESCRIPTION

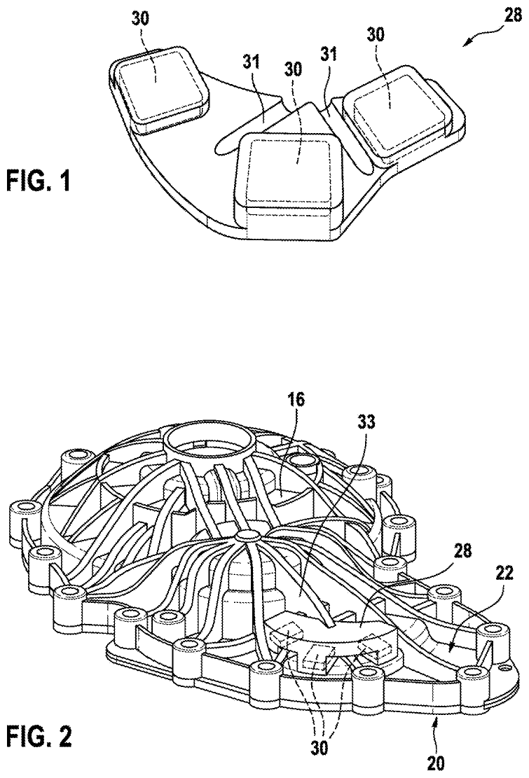

FIG. 1 shows a perspective view of a positioning device 28 according to a first exemplary embodiment. In the present case, the positioning device 28 has three magnets 30 arranged along a circular arc section.

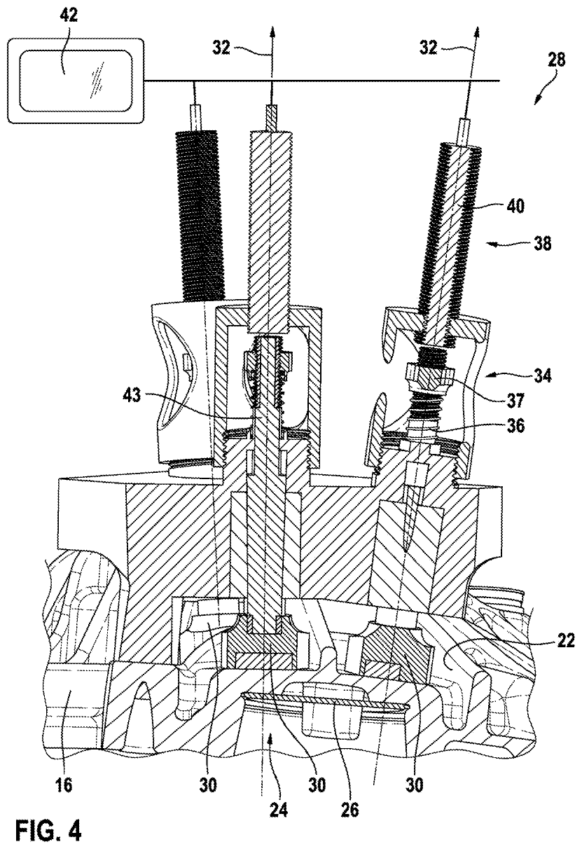

The positioning device 28 is designed to position a shim ring 26 during mounting of a rolling bearing 10 of a bearing arrangement 12 into a housing 14 with a first housing part 16 and a second housing part 18 (see FIG. 4). The first housing part 16 has an inner side 20 and an outer side 22 (see FIG. 2), where a bearing seat 24 for the rolling bearing 10 is arranged on the inner side 20 of the first housing part 16.

FIG. 2 shows a perspective view of the positioning device 28 according to FIG. 1, positioned on the outer side 22 of the first housing part 16. In the present case, the first housing part 16 is configured as a housing cover. The positioning device 28 is designed to be positioned on the outer side 22 of the first housing part 16. The positioning device 28 has recesses 31 for this purpose (see FIG. 2), which correspond to elevations 33 (or ribs) arranged on the outer side 22 of the first housing part 16.

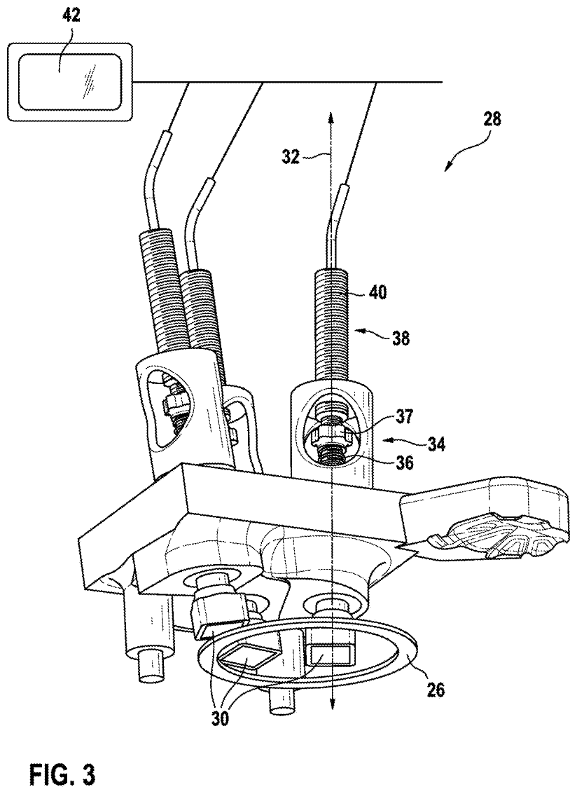

FIG. 3 shows a perspective view and FIG. 4 shows a cross-sectional view of the positioning device 28 according to a second exemplary embodiment. The second exemplary embodiment of the positioning device 28 differs from the first exemplary embodiment in the following:

In the present case, the positioning device 28 has three movable magnets 30. Each magnet 30 is movably configured along a respective direction of movement 32 between a first and a second position.

Each magnet 30 is biased by means of a biasing device 34. In the present case, the biasing device 34 comprises three coil springs 36, wherein each coil spring 36 biases a magnet 30 to the first position. In the first position, the magnets are maximally distant from the outer side 22 of the first housing part 16 when the positioning device 28 is positioned on the outer side 22 of the first housing part 16. In the second position, the magnets 30 are minimally distant from the outer side 22 of the first housing part 16 when the positioning device 28 is positioned on the outer side 22 of the first housing part 16. In the second position, the magnets 30 contact the outer side 22 of the first housing part 16. FIG. 4 shows the positioning device 28 in the second position.

The tension force of the coil springs 36, and thus the biasing force of the biasing device 34, can each be adjusted using an adjustment nut 37.

In the present case, the positioning device 28 comprises a sensor device 38. The sensor device 38 comprises three inductive encoders 40. By means of the three inductive encoders 40, it can be determined whether the magnets 30 are in the first or the second position. In the present case, the magnets 30 are arranged on lift rods 43, wherein movement of the magnets 30 along the direction of movement 32 also causes movement of the lift rods 43 along the direction of movement 32. The inductive encoders 40 are arranged and designed to detect a movement of the lift rods 43 and thus a movement of the magnets 30, in particular out of the first position.

The positioning device 28 further comprises a display device 42. In the present case, the display device 42 is connected or coupled to the sensor device 38 and is designed to indicate whether the sensor device 38 detects the magnets 30 as being arranged in the first or second position. The display device 42 is merely indicated schematically in the figures.

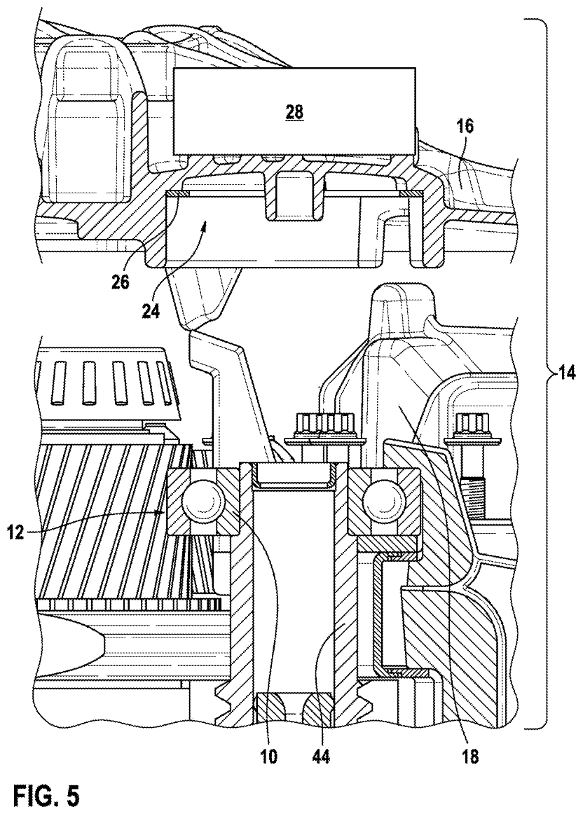

FIG. 5 shows a representation of a method for mounting the rolling bearing 10. First, the rolling bearing 10 is mounted on a shaft 44. The bearing arrangement 12 thus created, consisting of the rolling bearing 10 and a shaft 44, is mounted or positioned in the second housing part 18.

The positioning device 28 is positioned on the outer side 22 of the first housing part 16. The shim ring 26 is positioned (from below or on the inner side 20 of the first housing part 16) in the bearing seat 24.

The shim ring 26 is held in the bearing seat 24 due to magnetic interaction with the positioning device 28.

The first housing part 16 is then connected to the second housing part 18 or mounted on the second housing part 18. The rolling bearing 10 is pressed into the bearing seat 24, wherein the shim ring 26 is pressed between the rolling bearing 10 and in the bearing seat 24. The shim ring 26 is always held at the desired position by means of the magnetic interaction with the positioning device 28 in the bearing seat 24.

1. A method for mounting a rolling bearing (10) of a bearing arrangement (12) into a housing (14) having a first housing part (16) and a second housing part (18), wherein the first housing part (16) has an inner side (20) and an outer side (22), wherein a bearing seat (24) for the rolling bearing (10) is arranged on the inner side (20) of the first housing part (16), wherein the method comprises the following steps:
providing the bearing arrangement (12) with the rolling bearing (10);
positioning the bearing arrangement (12) in the second housing part (18);
providing a shim ring (26);
positioning the shim ring (20) on the bearing seat (24);
holding the shim ring (26) in the bearing seat (24) by magnetic interaction, and
connecting the first housing part (16) to the second housing part (18), wherein as a result of connecting the first housing part (16) to the second housing part (18), the rolling bearing (10) is pushed into the bearing seat (24), wherein during connecting the first housing part (16) to the second housing part (18), the shim ring (26) is held in the bearing seat (24) by the magnetic interaction.

2. The method according to claim 1, wherein the method comprises the following step:
outputting a signal when the position of the shim ring (26) in the bearing seat (24) deviates from a predetermined position.

3. The method according to claim 1, wherein, for performing the method, a positioning device (28) comprising at least one magnet (30) is used.

4. A positioning device (28) for positioning a shim ring (26) during mounting of a rolling bearing (10) of a bearing arrangement (12) into a housing (14) with a first housing part (16) and a second housing part (18), wherein the first housing part (16) has an inner side (20) and an outer side (22), wherein a bearing seat (24) for the rolling bearing (10) is arranged on the inner side (20) of the first housing part (16), wherein the positioning device (28) comprises at least one magnet (30), wherein the positioning device (28) is positionable on the outer side (22) of the first housing part (16) and is configured so that when the positioning device (28) is positioned on the outer side (22) of the first housing part (16), a shim ring (26) positioned in the bearing seat (24) is held in the bearing seat (24) by magnetic interaction between the shim ring (26) and the magnet (30) of the positioning device (28).

5. The positioning device (28) according to claim 4, wherein the positioning device (28) comprises a plurality of magnets (30), wherein the magnets (30) are arranged on or in the positioning device (28) such that the arrangement of the magnets (30) corresponds to a shape of at least a section of the shim ring (26).

6. The positioning device (28) according to claim 4, wherein the at least one magnet (30) is movably arranged or mounted in the positioning device (28) along a direction of movement (32) between a first position and a second position.

7. The positioning device (28) according to claim 6, wherein the positioning device (28) comprises a biasing device (34), wherein the at least one magnet (30) is biased to the first position by the biasing device (34).

8. The positioning device (28) according to claim 7, wherein the biasing device (34) is configured such that the biasing of the at least one magnet (30) adjustable.

9. The positioning device (28) according to claim 6, wherein the positioning device (28) comprises a sensor device (38), wherein the sensor device (38) is configured to detect whether the at least one magnet (30) is arranged in the second position.

10. The positioning device (28) according to claim 9, wherein the positioning device (28) comprises a display device (42), wherein the display device (42) is configured to display whether the at least one magnet (30) has been detected as being arranged in the second position by the sensor device (38).

11. The method according to claim 1, wherein the housing (14) is a gear housing, and wherein the first housing part (16) is a housing cover.

12. The method according to claim 1, wherein holding the shim ring (26) in the bearing seat (24) by magnetic interaction includes the use of a positioning device (28).

13. The method according to claim 2, wherein the signal is an optical signal.

14. The positioning device (28) according to claim 4, wherein the housing (14) is a gear housing, and wherein the first housing part (16) is a housing cover.

15. The positioning device (28) according to claim 5, wherein the positioning device (28) comprises three magnets (30).

16. The positioning device (28) according to claim 7, wherein the biasing device (34) includes at least one coil spring (36).

17. The positioning device (28) according to claim 9, wherein the sensor device (36) comprises at least one inductive encoder (40) for detection.

18. The positioning device (28) according to claim 10, wherein the display device (42) is an optical display device.
